(19) United States
(12) Patent Application Publication
(10) Pub. No.: US 2025/0209609 A1
(43) Pub. Date: Jun. 26, 2025

(54) METHOD AND SYSTEM FOR AUTOMATIC DEFECT DETECTION, COUNTING, AND LOCALISATION FROM VIDEO SEQUENCES

(71) Applicant: AGENCY FOR SCIENCE, TECHNOLOGY AND RESEARCH, Singapore (SG)

(72) Inventors: Yusha LI, Singapore (SG); Jierong CHENG, Singapore (SG); Wei XIONG, Singapore (SG)

(73) Assignee: AGENCY FOR SCIENCE, TECHNOLOGY AND RESEARCH, Singapore (SG)

(21) Appl. No.: 18/847,003

(22) PCT Filed: Mar. 16, 2024
(86) PCT No.: PCT/SG2023/050167

§ 371 Date: Sep. 13, 2024

(30) Foreign Application Priority Data
Mar. 17, 2022 (SG) 10202202717P

(51) Int. Cl. G06T 7/00

(52) U.S. Cl. CPC G06T 7/001; G06T 2207/20084; G06T 2207/30164; G06T 2207/30241

(57) ABSTRACT

This disclosure relates to method and system for inspection of rotational components based on video frames of the rotational components in motion. Based on the property of projective single axis motion, motion trajectories of defects on the rotational components are modeled in a conic pattern. The defects are clustered according to their spatial information around a rotation axis of the rotational components to ascertain distinct defects. Undetected defects may be recovered by rotating their previous locations along their trajectory conics by a predetermined rotation angle. Based on the distinct defects, including the recovered defect, a modified video frame which includes an identification of the distinct defects, including the recovered defect, may be generated.

### TECHNICAL FIELD

This disclosure generally relates to visual based inspection of objects including rotational components such as rotating blades in aircraft engine, wind turbine, or water turbines, and real-time objects on conveying belt. In particular, the visual inspection may involve defect detection, defect clustering, defect localization, defect recovery, and fusion or aggregation of defect information.

### BACKGROUND

During inspection of a set of blades, a still camera obtains a video sequence of the blades while they continuously rotate back and forth for inspection. Due to inherent issues in such inspection video sequence, conventional defect analysis methods are not satisfactory.

For example, to obtain a composite image containing all the detected defects for each blade, there are mainly two challenges, i.e., count the distinct defects on each blade, and find the defect locations on the blade. Conventional image fusion methods can integrate all the images captured from multiple views, multiple sensors or multiple temporal together to provide a more enhanced representation. One basic operation of image fusion is image registration which is to align the images according to their features. Features on several images may then be merged together. In typical video sequence of rotating blades, however, images of the same blade acquired from different views may exhibit different subsets of defects. Furthermore, defects on the blade may be limited and not distinguishable. Yet furthermore, the same defect may present different appearances in different views and even different defects may have similar appearance. Other than defects, there may be no distinct features on the blade.

For example, object tracking, i.e., continuously tracking each defect from appearance to disappearance in the video frames, is also challenging. Defects easily lose track due to the illumination change. Conventional object tracking methods may use object trajectory prediction to handle occlusion problems in object detection. Such methods for future location prediction include vector-based prediction, pattern-based prediction and semantic-aware methods, but are also unsatisfactory.

### SUMMARY

According to a first aspect of the disclosure, a method for inspection of rotational components comprises:
based on a plurality of video frames of the rotation components in motion, ascertaining a plurality of trajectories of a plurality of defects on the rotational components;
based on a plurality of fitted ellipses of a plurality of subsets of the trajectories, ascertaining a plurality of rotation axes; and
based on a distribution of the rotation axes, ascertaining a reference rotation axis for the rotational components.

In an embodiment of the first aspect, the method further comprises:
clustering the defects by:
   for each of a plurality of subsets of the trajectories wherein each subset includes at least a first and a second trajectory:
   based on the reference rotation axis and the first and the second trajectory, ascertaining a reference trajectory;
   ascertaining fit or non-fit characteristic of the reference trajectory against the first and the second trajectory;
   ascertaining the defects which correspond to the first and the second trajectory as distinct defects if non-fit characteristic is ascertained.

In an embodiment of the first aspect, the method further comprises:
identifying corresponding rotational components for the defects by:
for each video frame, ascertaining a rotational component count;
   based on the rotational component count and the reference trajectory, assigning the corresponding rotational components to the defects.

In an embodiment of the first aspect, the step of clustering the defects further includes:
ascertaining the some of the defects as distinct defects if the following conditions are complied with: the fit characteristic is ascertained; and the corresponding rotational components of the first and the second trajectory are distinct.

In an embodiment of the first aspect, the method further comprises:
ascertaining undetected positions of the defects on the corresponding rotational components, including:
   for at least one missing defect which is detected in an occurrence video frame and undetected in a non-occurrence video frame, ascertaining an undetected position for the missing defect in the non-occurrence video frame by:
      identifying a reference defect which is detected in the occurrence and the non-occurrence video frame,
      ascertaining a rotation angle of the reference defect by ascertaining a progression of fitted ellipses of the reference defect which correspond to a progression from the occurrence video frame to the non-occurrence video frame;
      based on the rotation angle, ascertaining a recovered defect in the non-occurrence video frame, the recovered defect being the undetected position for the missing defect in the non-occurrence video frame,
wherein the video frames include the occurrence frame and the non-occurrence video frame, and wherein the defects include the missing or recovered defect and the reference defect.

In an embodiment of the first aspect, the step of clustering the defects further includes:
ascertaining the some of the defects, including the recovered defect, as distinct defects if the following conditions are complied with: the fit characteristic is ascertained; and the corresponding rotational components of the first and the second trajectory are same; and the ascertained positions of the some of the defects are distinct;
ascertaining the some of the defects, including the recovered defect, as same defects if the following conditions are complied with: the fit characteristic is ascertained; the corresponding rotational components of the first and the second trajectory are same; and the ascertained positions of the some of the defects are same.

In an embodiment of the first aspect, the method further comprises:
based on at least some of the video frames and distinct defects, including the recovered defect, generating at least one modified image which includes an identification of the distinct defects, including the recovered defect.

In an embodiment of the first aspect, the method further comprises: based on the modified video frame, ascertaining a count of distinct defects therein.

In an embodiment of the first aspect, the step of ascertaining the trajectories of the defects on the rotational components includes:
based on mapping features of each defect over a plurality of successive frames of the video frames, ascertaining the trajectories.

According to a second aspect of the disclosure, a system for inspection of rotational components comprises:
a memory device storing a plurality of video frames; and
a computing processor communicably coupled to the memory device and configured to:
   based on the video frames of the rotation components in motion, ascertain a plurality of trajectories of a plurality of defects on the rotational components;
   based on a plurality of fitted ellipses of a plurality of subsets of the trajectories, ascertain a plurality of rotation axes; and
   based on a distribution of the rotation axes, ascertain a reference rotation axis for the rotational components.

In an embodiment of the second aspect, the computing processor is further configured to:
cluster the defects by:
   for each of a plurality of subsets of the trajectories wherein each subset includes at least a first and a second trajectory:
      based on the reference rotation axis and the first and the second trajectory, ascertaining a reference trajectory;
      ascertaining fit or non-fit characteristic of the reference trajectory against the first and the second trajectory;
      ascertaining the defects which correspond to the first and the second trajectory as distinct defects if non-fit characteristic is ascertained.

In an embodiment of the second aspect, the computing processor is further configured to:
identify corresponding rotational components for the defects by:
   for each video frame, ascertaining a rotational component count;
      based on the rotational component count and the reference trajectory, assigning the corresponding rotational components to the defects.

In an embodiment of the second aspect, the computing processor is configured to cluster the defects by ascertaining the some of the defects as distinct defects if the following conditions are complied with: the fit characteristic is ascertained; and the corresponding rotational components of the first and the second trajectory are distinct.

In an embodiment of the second aspect, the computing processor is further configured to:
ascertain undetected positions of the defects on the corresponding rotational components, including:
   for at least one missing defect which is detected in an occurrence video frame and undetected in a non-occurrence video frame, ascertaining an undetected position for the missing defect in the non-occurrence video frame by:
   identifying a reference defect which is detected in the occurrence and the non-occurrence video frame,
   ascertaining a rotation angle of the reference defect by ascertaining a progression of fitted ellipses of the reference defect which correspond to a progression from the occurrence video frame to the non-occurrence video frame;
   based on the rotation angle, ascertaining a recovered defect in the non-occurrence video frame, the recovered defect being the undetected position for the missing defect in the non-occurrence video frame,
   wherein the video frames include the occurrence frame and the non-occurrence video frame, and wherein the defects include the missing or recovered defect and the reference defect.

In an embodiment of the second aspect, the computing processor is configured to cluster the defects by:
ascertaining the some of the defects, including the recovered defect, as distinct defects if the following conditions are complied with: the fit characteristic is ascertained; and the corresponding rotational components of the first and the second trajectory are same; and the ascertained positions of the some of the defects are distinct;
ascertaining the some of the defects, including the recovered defect, as same defects if the following conditions are complied with: the fit characteristic is ascertained; the corresponding rotational components of the first and the second trajectory are same; and the ascertained positions of the some of the defects are same.

In an embodiment of the second aspect, the computing processor is further configured to:
based on at least some of the video frames and distinct defects, including the recovered defect, generating at least one modified image which includes an identification of the distinct defects, including the recovered defect.

In an embodiment of the second aspect, the computing processor is further configured to:
based on the modified video frame, ascertain a count of distinct defects therein.

In an embodiment of the second aspect, the computing processor is configured to ascertain the trajectories of the defects on the rotational components by:
based on mapping features of each defect over a plurality of successive frames of the video frames, ascertaining the trajectories.

### BRIEF DESCRIPTION OF THE DRAWINGS

FIG. 1A shows an overview flow sequence of a method for inspection of rotational components according to an embodiment.

FIG. 1B shows a flow sequence for defect trajectory fitting according to an embodiment.

FIG. 1C shows a flow sequence for clustering defects according to an embodiment.

FIG. 1D shows a flow sequence for recovering undetected or missing defects.

FIG. 1E shows another flow sequence for recovering an undetected or missing defect.

FIG. 2 shows tracking results of all detected defects within one video sequence.

FIG. 3 shows application of Scale-Invariant Feature Transform (SIFT) matching within the defect region between two successive frames.

FIG. 4 shows a selected feature matching path to represent the motion of a defect.

FIG. 5 shows a representation of ascertaining reference rotation axis from a pair of trajectories.

FIG. 6 shows a plurality of rotation axes and a reference rotation axis 150 which is ascertained therefrom.

FIG. 7 shows selection of best fit ellipse based on a group of fitted ellipses.

FIG. 8A shows a video frame for which a rotational component count is ascertained as three; FIG. 8B shows that the rotational components are identified or separated by rotational component edge information.

FIG. 9 is a graphical representation for matched pairs of trajectories.

FIG. 10 shows distinct defect trajectories after defect clustering of input defects represented by FIG. 2.

FIGS. 11A to 11C illustrate recovery of a missing defect.

FIG. 12A shows an input video frame; FIG. 12B shows a modified video frame based on FIG. 12A and outputs from defect clustering and defect recovery.

FIG. 13A shows an input video frame; FIG. 13B shows a modified video frame based on FIG. 13A and outputs from defect clustering and defect recovery.

FIG. 14A shows an input video frame; FIG. 14B shows a modified video frame based on FIG. 14A and outputs from defect clustering and defect recovery.

### DETAILED DESCRIPTION

In the following description, numerous specific details are set forth in order to provide a thorough understanding of various illustrative embodiments of the invention. It will be understood, however, to one skilled in the art, that embodiments of the invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, including examples and claims, the articles “a”, “an” and “the” as used with regard to a feature or element include a reference to one or more of the features or elements. The terms “comprising,” “including,” and “having” are intended to be open-ended and mean that there may be additional features or elements other than the listed ones. The term “and/or” includes any and all combinations of one or more of the associated listed items.

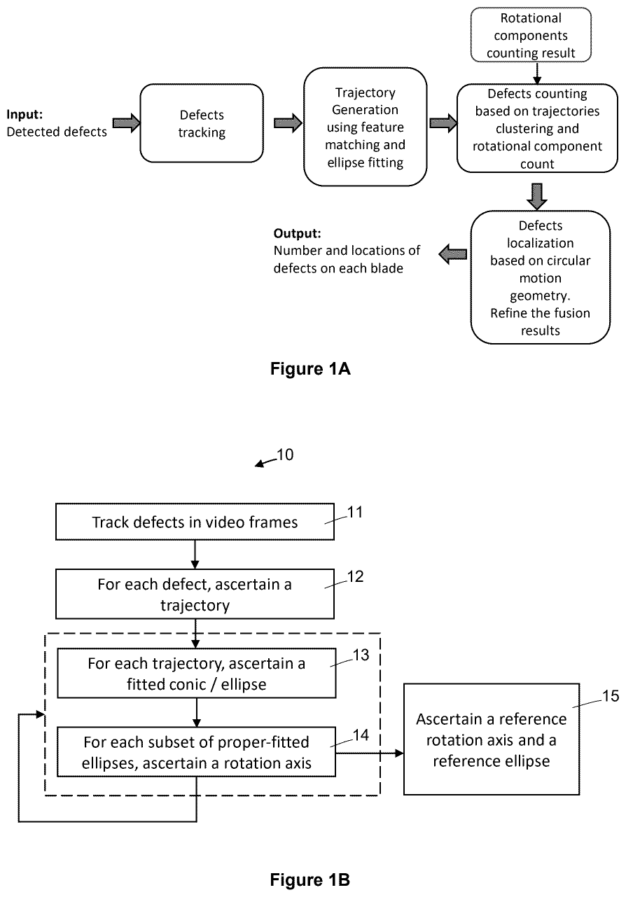

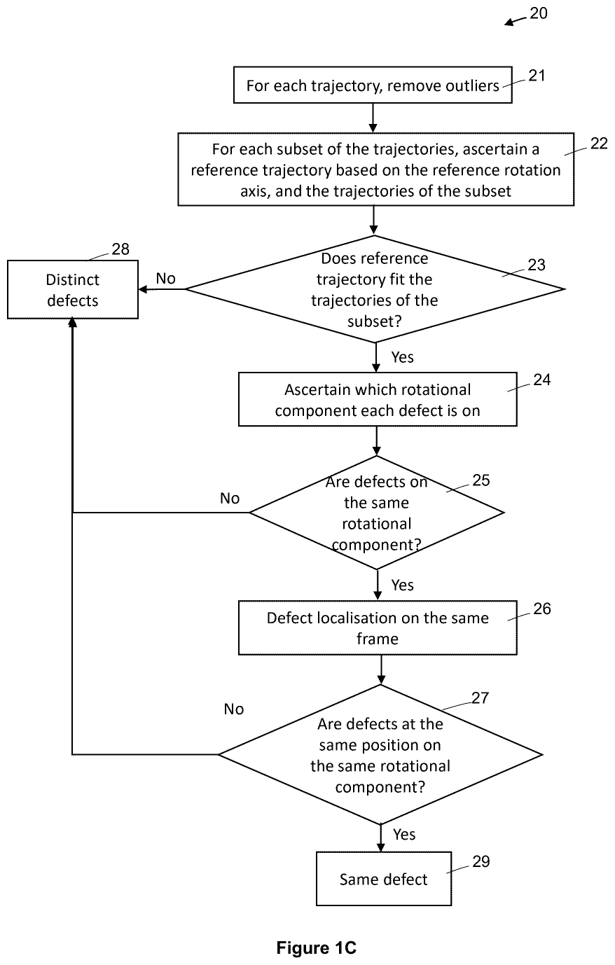

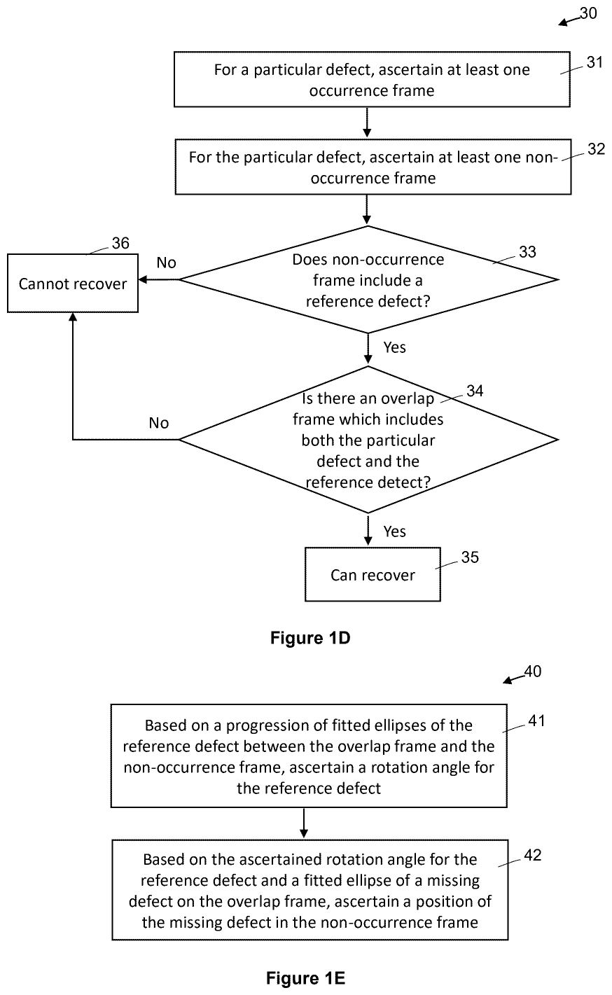

FIG. 1A shows an overview flow sequence of a method for inspection of rotational components according to an embodiment. Various aspects of the method are further described by flow sequences in FIGS. 1B to 1E.

FIG. 1B shows a flow sequence 10 for defect trajectory fitting according to an embodiment in which, based on detection and tracking results, a motion trajectory of each defect is ascertained; based on the property of projective single axis motion, the motion trajectories on screen can be modeled in a conic pattern.

The flow sequence of FIG. 1B may be performed based on an obtained video sequence having a plurality of video frames of rotational components in motion, e.g. input of FIG. 1A. The video frames include labelled defects on the rotational components. The video frames may be processed to remove duplicate defects, e.g. defects in successive frames with same or almost same locations on the screen.

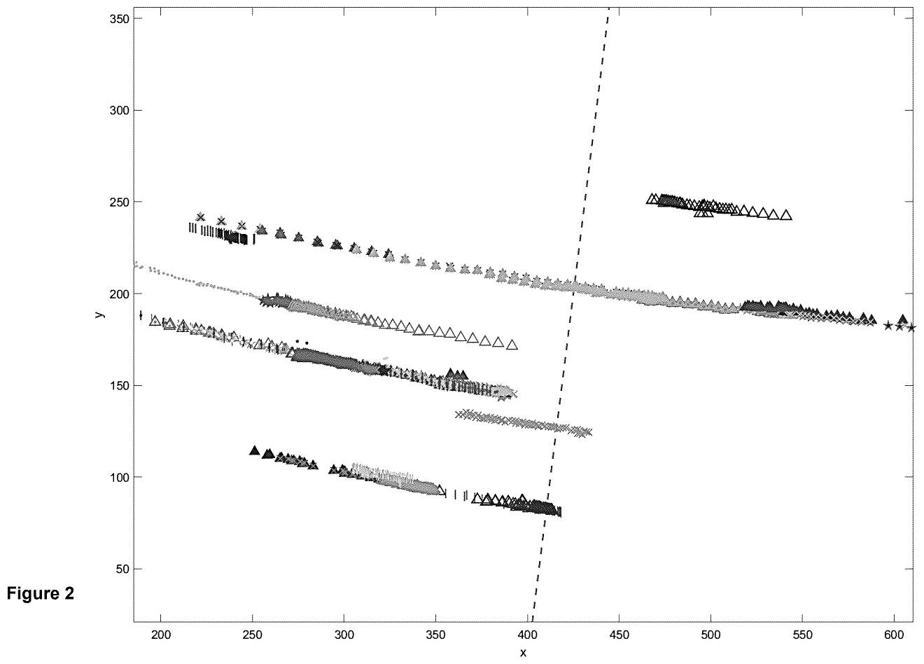

In block 11 of FIG. 1B, a plurality of defects in the video frames are tracked. This may be performed by a conventional method, e.g., Multi-Domain Convolutional Neural Network (MDNet), or other deep neural network object tracking algorithm. FIG. 2 shows tracking results of all detected defects within one video sequence. The points on the figure are centres of defect bounding boxes.

In block 12, for each defect, a trajectory is ascertained, e.g. based on the tracked defects and/or SIFT mapping as described below. Accordingly, a plurality of trajectories are ascertained for the plurality of defects on the rotational components.

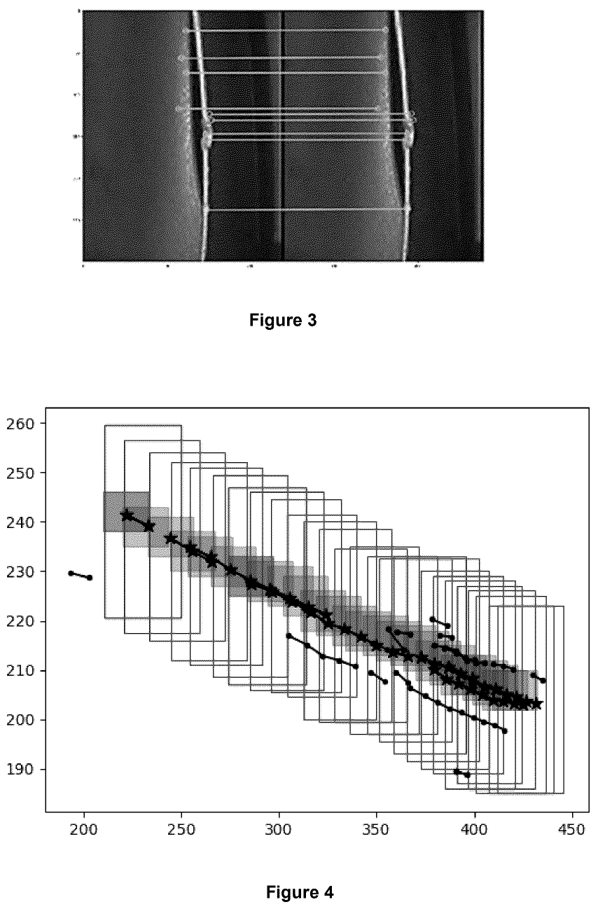

These trajectories may be generated by applying Scale-Invariant Feature Transform (SIFT) matching within the defect region between two successive frames as shown in FIG. 3. The defect is matched with itself in the next frame. While the view and illumination are continuously changing, the features between successive frames of one defect are mostly preserved and hence feature matching path can be generated. FIG. 4 shows a selected feature matching path to represent the motion of a defect. The connected points are matched features between successive frames. As there are multiple feature paths, one sub-region within the defect is identified and the longest path with most number of nodes inside the sub-region may be taken as the trajectory of this defect. This sub-region may be selected at the centre among the feature distribution. The path which is represented by connected stars is the selected trajectory representing the motion of one defect. Non-shaded rectangles are the bounding boxes of the defect. Shaded rectangles are the centre regions among the feature distribution. Points which are represented by stars and dots are SIFT feature points with connections indicating their matching status.

In block 13, two fitted conics, e.g. fitted ellipses, are ascertained based on each subset, e.g. pairs, of the trajectories. For example, conic or ellipse may be fitted using a minimum number of points which are randomly selected from any trajectory. Accordingly, a plurality of fitted conics, e.g. fitted ellipses, are ascertained based on a plurality of subsets, e.g. pairs, of the trajectories.

In block 14, a rotation axis is ascertained based on each subset, e.g. pair, of proper-fitted conics, e.g. fitted ellipses. For all proper-fitted ellipses, rotation axes are ascertained based on ellipse pairs. Accordingly, a plurality of rotation axes for the rotational components are ascertained based on the plurality of subsets, e.g. pairs, of proper-fitted conics, e.g. proper-fitted ellipses.

In block 15, a reference rotation axis, e.g. optimal rotation axis, for the rotational components is ascertained or selected based on a distribution of all the rotation axes. Based on the reference rotation axis, a reference ellipse, e.g. optimal ellipse, may be ascertained or selected for each trajectory.

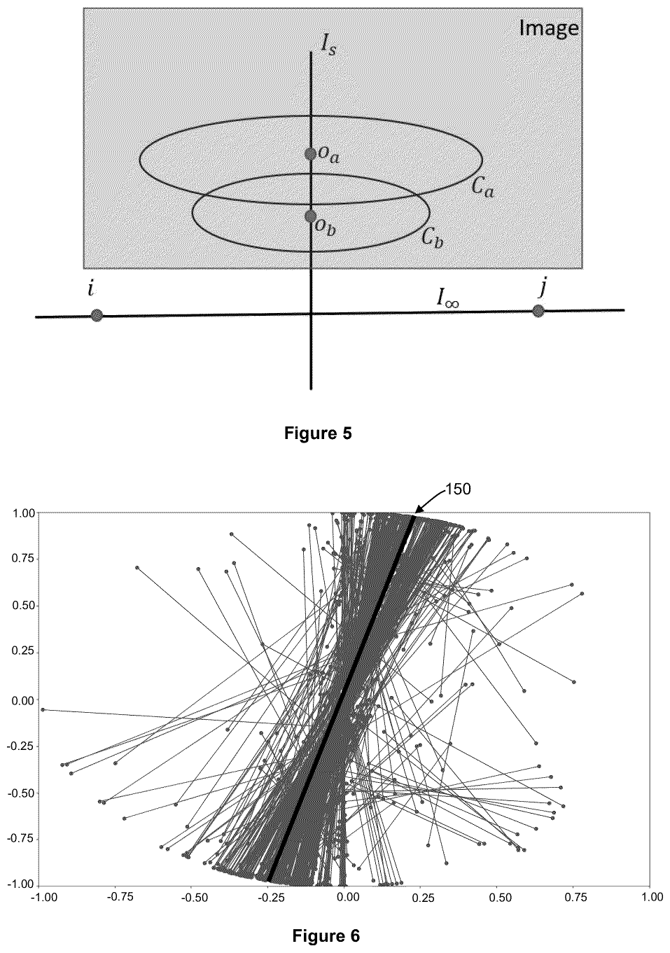

Steps in block 13 to block 15 for ascertaining a reference rotation axis for the rotational components, may be described as follows with reference to FIG. 5:
(i) Choose two subset points from two trajectories (at least 5 points).
(ii) Fit two conics Cₐ and C_{b} based on the subset of points.
(iii) Compute the intersection of two fitted conics. If the solution is a unique pair of complex conjugates, they are the images of circular points i and j. If there are two pairs of complex conjugate points, the ambiguity can be removed by using one additional conic.
(iv) Compute the vanishing line

$${I}_{∞} = i \times j$$

(v) Compute the projection of the two circle centers

$${o}_{a} = {C}_{a}^{- 1} {I}_{∞} \\ {o}_{b} = {C}_{b}^{- 1} {I}_{∞}$$

(vi) Compute the rotation axis

$${I}_{s} = {o}_{a} \times {o}_{b}$$

(vii) Steps (i) to (vi) are iterated until, for example, all trajectories have been chosen.
(viii) Select a reference rotation axis based on the distribution of the ascertained rotation axes.

FIG. 6 shows a plurality of rotation axes and a reference rotation axis 150 which is ascertained therefrom.

FIG. 1C shows a flow sequence 20 for clustering defects according to an embodiment to ascertain distinct defects. With the ascertained trajectories of all the defects, the defects may be clustered according to their spatial information around the rotation axis of the rotational components to ascertain distinct defects. Since the rotational component is rotating around a single axis, the trajectory of each defect on screen space is a conic which is obtained by projecting a circle from 3-dimensional space to 2-dimensional screen. Defects on different conics are necessary distinct defects. However, defects moving along the same conic may potentially be distinct or non-distinct defects. Hence, it is ascertained which conic each defect is on and whether the defects are moving along the same conic; subsequently, location information of each defect with respect to the rotational components is ascertained.

In block 21 of FIG. 1C, each of the trajectories may be processed to remove outliers. This may be performed using random sample consensus (RANSAC) algorithm.

In block 22, for each subset, e.g. pair, of the trajectories, wherein each subset includes at least a pair of trajectories, e.g. a first and a second trajectory, a reference or optimal trajectory is ascertained based on the reference rotation axis, and the first and the second trajectory. The reference or optimal trajectory may alternatively be referred to as a reference or optimal ellipse.

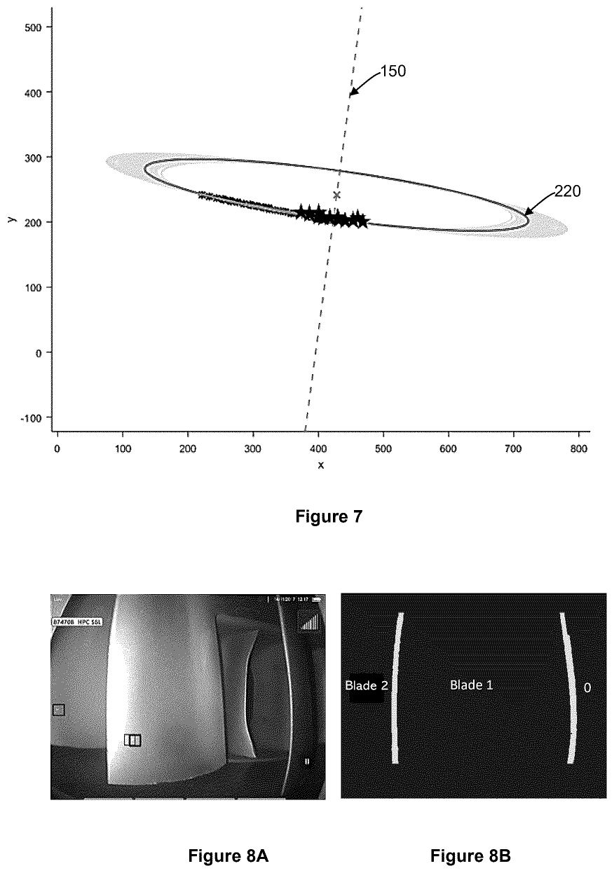

For example, data points of two trajectories may be combined; an ellipse derivation may be ascertained using the combined data based on the reference rotation axis. Alternatively, as shown in FIG. 7, a best fit ellipse may be selected based on a group of ellipses fitted using subset of the combined data. FIG. 7 also shows ellipse fitting based on a reference rotation axis 150. Points which are represented by asterisks and stars are a pair of defect trajectories. The illustrated ellipses are fitted using subset points on the defect trajectories and an optimal ellipse 220 is selected as the reference trajectory.

In block 23, a fit or non-fit characteristic of the reference trajectory against the first and the second trajectory is ascertained, e.g. it is ascertained whether the reference trajectory fits both the first and the second trajectory. This may be performed by ascertaining point to ellipse distance. If the percentage of both trajectory points on this reference ellipse is larger than a predetermined threshold, both the first and the second trajectory are considered to be on the same or matched trajectory, i.e. the reference trajectory is ascertained as having a fit characteristic. If the percentage of both trajectory points on this reference ellipse is no larger than the predetermined threshold, both the first and the second trajectory are considered to be on distinct or unmatched trajectories, i.e. the reference trajectory is ascertained as having a non-fit characteristic.

If the reference trajectory is ascertained as having non-fit characteristic, block 23 proceeds to block 28 in which it is ascertained that those defects corresponding to the first and the second trajectory are distinct defects.

If the reference trajectory is ascertained as having fit characteristic, block 23 proceeds to block 24 in which corresponding rotational components for the defects corresponding to the first and the second trajectory are ascertained. Additionally, corresponding rotational components for other defects may also be ascertained.

Identifying a rotational component corresponding to each defect may be performed as follows. For each video frame, a rotational component count for rotational components occurring in the video frame is ascertained. This may be performed using conventional techniques which may utilize rotational component edge information. Based on the ascertained rotational component count for the particular video frame and the ascertained reference trajectory corresponding to the particular video frame, a corresponding rotational component is identified for each defect, e.g. a corresponding rotational component is assigned to a corresponding trajectory of each defect.

For example, FIG. 8A shows a video frame for which a rotational component count is ascertained as three, as partial view of rightmost rotational component is not included in the rotational component count. FIG. 8B shows that the rotational components are identified or separated by rotational component edge information. To make the result more robust, for one of the defects, its tracking results may be used, e.g. the rotational component count of this defect is obtained by votes from all the defects on the tracking trajectory. After this step, the defects have been assigned to distinct rotational components.

In block 25, after a corresponding rotational component is identified for each defect, it is ascertained whether the defects are located on same rotational component or distinct rotational components. Particularly, it is ascertained whether corresponding defects of the first and the second trajectory are located on the same rotational component or distinct rotational components.

If it is ascertained that the corresponding defects of the first and the second trajectory are located on different rotational components, block 25 proceeds to block 28 in which it is ascertained that defects corresponding to the first and the second trajectory are distinct defects.

If it is ascertained that the corresponding defects of the first and the second trajectory are located on same rotational components, block 25 proceeds to block 26.

In block 26, positions of defects on each rotational component are ascertained, e.g. computed and/or received. For defects which are detected on video frames, their positions may be obtained, e.g. from the input of FIG. 1A and block 11. For defects which are detected in some video frames but undetected in other video frames, a more detailed description of recovering or ascertaining undetected defects in video frame is provided in later paragraphs.

In block 27, it is ascertained whether the defects on the same rotational component are the same defect or distinct defects. Particularly, it is ascertained whether corresponding defects of the first and the second trajectory are located at the same position or distinct positions on the same rotational component.

If it is ascertained that the corresponding defects of the first and the second trajectory are located at different positions, block 27 proceeds to block 28 in which it is ascertained that defects corresponding to the first and the second trajectory are distinct defects.

If it is ascertained that the corresponding defects of the first and the second trajectory are located at same position, block 27 proceeds to block 29 in which it is ascertained that defects corresponding to the first and the second trajectory are same defect.

Accordingly, defects in the video frames may be clustered as distinct defects or same defect.

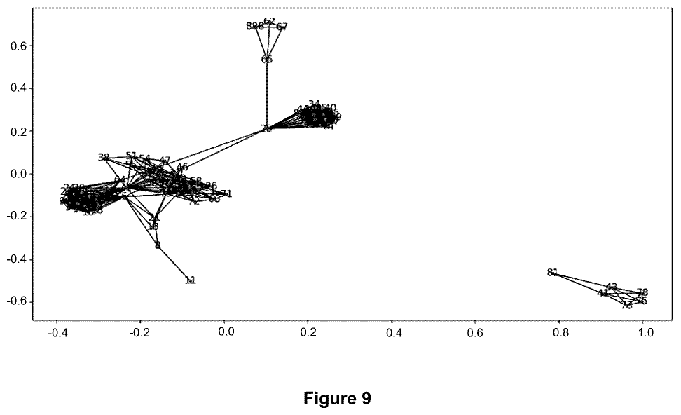

Based on blocks 21 to 29, a graphical representation as shown in FIG. 9 may be generated for matched pairs of trajectories. The graphical representation is partitioned into cliques which means in each separated group any of two nodes are connected. Each clique includes a group of trajectories that are on the same ellipse. FIG. 9 shows five cliques corresponding to five distinct defects.

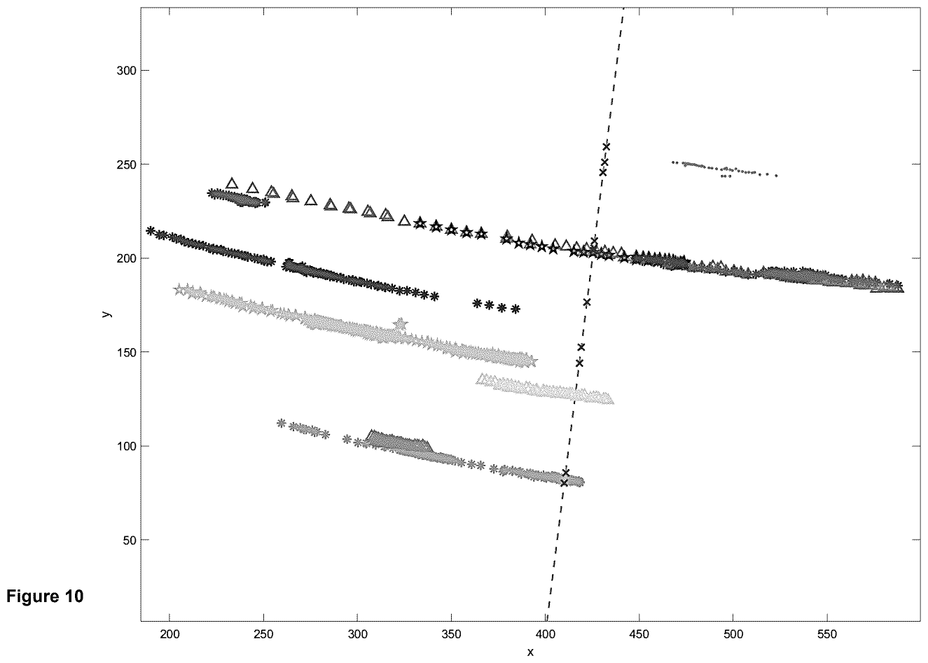

Furthermore, based on blocks 21 to 29, a representation of clustered defects may be generated. Such representation may identify clustered defects and provide a clustered defect count, i.e. distinct defect count. For example, FIG. 2 shows defect trajectories prior to defect clustering and provides a defect count of 79 while FIG. 10 shows defect trajectories after defect clustering of input defects represented by FIG. 2 and provides a clustered or distinct defect count of 11. Accordingly, duplicates in detected defects are reduced or eliminated to provide a more accurate count of distinct defects.

FIG. 1D shows a flow sequence 30 for recovering undetected defects. For each defect, it may be detected in some video frames but undetected or out of the camera view in the remaining video frames. In such remaining frames, this defect may be positioned by rotating one of its previous locations along its trajectory conic by a predetermined rotation angle. The rotation angle is computed based on other reference defect that occurs in the same frame with the defect to be recovered.

In block 31 of FIG. 1D, for each or any particular defect, e.g. first defect, at least one occurrence frame in which the particular defect is detected, e.g. first video frame, is ascertained from among the video frames.

In block 32, at least one non-occurrence frame in which the particular defect is undetected or missing, e.g. second video frame, is ascertained from among the video frames.

In block 33, based on the non-occurrence frame, it is ascertained whether there is at another or reference defect detected therein.

If it is ascertained that the non-occurrence frame does not include another or reference defect, block 33 proceeds to block 36 in which it is ascertained that the particular or missing defect, e.g. first defect, cannot be recovered in the non-occurrence frame.

If it is ascertained that the non-occurrence frame includes another or reference defect, e.g. second defect, block 33 proceeds to block 34 in which it is ascertained whether there is at least one overlap frame in which both the particular or missing defect and the reference defect are detected.

If it is ascertained in block 34 that there is no such overlap frame, block 34 proceeds to block 36 in which it is ascertained that the particular or missing defect cannot be recovered in the non-occurrence frame.

If it is ascertained in block 34 that there is an overlap frame, e.g. first video frame, block 34 proceeds to block 35 in which the particular or missing defect is recovered in its non-occurrence frame, e.g. the second video frame. It is to be appreciated that the overlap frame is necessarily an occurrence frame, hence the overlap frame may be referred to by the first video frame, but not every occurrence frame is an overlap frame.

In block 36 wherein a reference defect cannot be located, a rotation angle may be approximately inferred by intersecting the trajectory with the two rotational component edges in two video frames. The rotating angle can be roughly computed using the two trajectory-edges intersection points in the two video frames.

FIG. 1E shows a flow sequence 40 for recovering a missing defect, e.g. first defect, in its non-occurrence frame, e.g. second video frame, in which the missing defect, e.g. first defect, is undetected but a reference defect, e.g. second defect is detected, based on an overlap frame, e.g. first video frame, in which both the missing defect and reference defect, e.g. the first defect and the second defect, are detected.

In block 41 of FIG. 1E, based on a progression of fitted ellipses of the reference defect, e.g. second defect, between the overlap frame, e.g. first video frame, and the non-occurrence frame, e.g. second video frame, a rotation angle of the reference defect, e.g. second defect, is ascertained. Alternatively, the rotation angle may be based on a progression between the non-occurrence frame and the overlap frame.

In block 42, based on the ascertained rotation angle and a fitted ellipse of the missing defect, e.g. first defect, in the overlap frame, e.g. first video frame, a position of the missing defect in the non-occurrence frame, e.g. second video frame, is ascertained. Accordingly, the missing defect is recovered which may alternatively be referred to as a recovered defect.

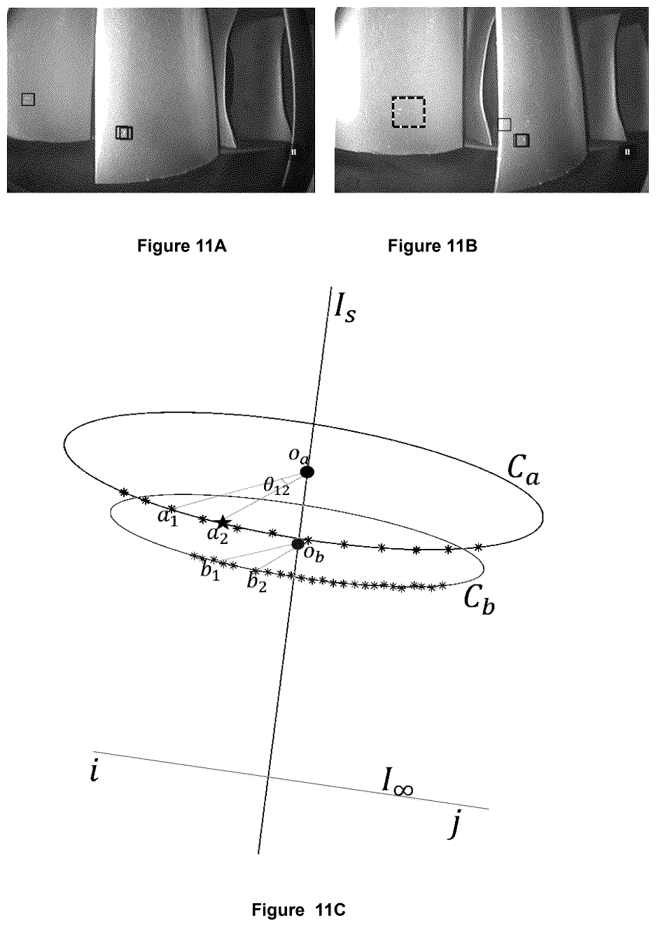

FIGS. 11A to 11C illustrate recovery of a missing defect. FIG. 11A shows a video frame with two detected defects two (left and right) rotational components respectively. FIG. 11B shows another video frame in which the defect on left rotational component is undetected (dash box indicates the location of the undetected defect). FIG. 11C shows the recovered point as star point on the trajectory of the defect a along conic Cₐ. The defect b along conic C_{b} is used as reference defect to compute the rotation angle as 0.2645 radian. The data points on the ellipses indicate its occurrence points.

For example, Laguerre's formula may be applied. A rotation angle between two points on a conic Cₐ can be obtained using

$${θ}_{12} = \frac{1}{2 i} log ( \{ {I}_{{o}_{a} {a}_{1}} , {I}_{{o}_{a} {a}_{2}} ; {I}_{{o}_{a} i} , {I}_{{o}_{a} j} \} )$$

where Iₒ_{ₐ}ₐ_{₁}=oₐ×a₁ and oₐ is the center of the conic Cₐ. a₁ and a₂ are two points on the conic which can be for one tracked defect (missing defect) a_{□}in the occurrence video frame and the non-occurrence video frame.

If the reference defect b is both in the occurrence video frame and the non-occurrence video frame but the missing defect a can only be seen in the occurrence video frame, the position of the missing defect a in the non-occurrence video frame is to be recovered. Theoretically, the missing defect a and the reference defect b are rotated the same angle from the occurrence video frame to the non-occurrence video frame. That means:

$$\frac{1}{2 i} log ( \{ {I}_{{o}_{a} {a}_{1}} , {I}_{{o}_{a} {a}_{2}} ; {I}_{{o}_{a} i} , {I}_{{o}_{a} j} \} ) = \frac{1}{2 i} log ( \{ {I}_{{o}_{b} {b}_{1}} , {I}_{{o}_{b} {b}_{2}} ; {I}_{{o}_{b} i} , {I}_{{o}_{b} j} \} )$$

Therefore, after ascertaining the rotation angle θ₁₂ based on b₁ (position of reference defect in the occurrence video image) and b₂ (position of reference defect in the non-occurrence image), the ellipse is discretized and a point is ascertained so that the angle between b₂ and the point (recovered point) equals to θ₁₂.

In an embodiment, a plurality of modified video frames may be generated for the video frames, e.g. input in FIG. 1A and block 11, respectively. Each modified video frame may include defect information fused or aggregated from multiple video frames. In particular, each modified image may be generated based on multiple video frames (e.g. at least some of the video frames), distinct defects ascertained from output(s) of blocks 21 to 29 for these video frames, recovered defects ascertained from output(s) of blocks 31 to 35, and 41 to 42 for these video frames. Hence, each modified image includes an identification of distinct defects, including recovered defects, on the rotational components. For example, such image may be derived from multiple video frames by inferring the position of a defect on its trajectory in a specified video frame based on the circular motion geometry theory. The modified image frame may further provide a count of distinct defects, including recovered defects. The count may be ascertained based on the modified image.

The modified video frames may provide a modified video sequence.

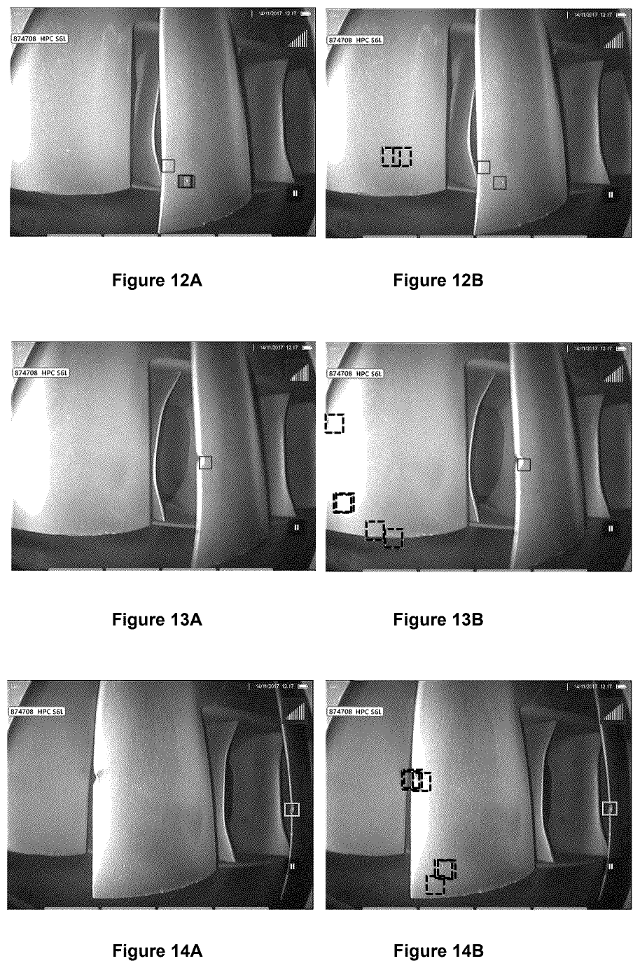

For example, FIGS. 12A, 13A, 14A may be an input video sequence of the rotational components in motion. FIG. 12B, 13B, 14B may be a modified video sequence which further includes identification of distinct defects, including recovered defects.

According to one aspect of the disclosure, a system for inspection of rotating components may be provided. The system comprises one or more computing processor(s), memory device(s), input device(s), output device(s), communication device(s), etc. The computing processor(s) may be in cooperation or communication coupling with: memory devices(s) for storing computer-executable instructions, video data, image frames, intermediate output and/or final output; a display device for presenting any ascertained outputs to an operator, and/or a communication device for transmitting any ascertained outputs to an appropriate receiving device. Such outputs may refer to outputs in the above-described flow sequences and/or embodiments. It is to be appreciated that in the above-described methods and in the flow sequence of FIG. 1A to 1E, the various steps may be performed or implemented by the computing processor(s).

According to one aspect of the disclosure, a non-transitory computer-readable medium having computer-readable code executable by at least one computing processor is provided to perform the methods/steps as described in the foregoing.

Embodiments of the disclosure provide at least the following advantages:
a. Defects can be clustered based on the rotational components identified and the correlated spatial information of the ellipses around the rotation axis of the cluster of rotational components. This enables identification of distinct or duplicate defects and hence more accuracy in defect counting.
b. Defects missing in certain video images, e.g. due to high reflective regions, illumination issues, out of view, can be recovered.
c. Defects detected in multiple views and recovered defects can be fused into a single image to provide a clear view of the number and locations of the distinct defects on each rotational component.

Other embodiments will be apparent to those skilled in the art from consideration of the specification and practice of the disclosure. Furthermore, certain terminology has been used for the purposes of descriptive clarity, and not to limit the disclosed embodiments. The embodiments and features described above should be considered exemplary.

1. A method for inspection of rotational components, the method comprising:
based on a plurality of video frames of the rotation components in motion, ascertaining a plurality of trajectories of a plurality of defects on the rotational components;
based on a plurality of fitted ellipses of a plurality of subsets of the trajectories, ascertaining a plurality of rotation axes; and
based on a distribution of the rotation axes, ascertaining a reference rotation axis for the rotational components.

2. The method of claim 1, further comprising:
clustering the defects by:
for each of a plurality of subsets of the trajectories wherein each subset includes at least a first and a second trajectory:
based on the reference rotation axis and the first and the second trajectory, ascertaining a reference trajectory;
ascertaining fit or non-fit characteristic of the reference trajectory against the first and the second trajectory;
ascertaining the defects which correspond to the first and the second trajectory as distinct defects if non-fit characteristic is ascertained.

3. The method of claim 2, further comprising:
identifying corresponding rotational components for the defects by:
for each video frame, ascertaining a rotational component count;
based on the rotational component count and the reference trajectory, assigning the corresponding rotational components to the defects.

4. The method of claim 3, wherein clustering the defects further includes:
ascertaining the some of the defects as distinct defects if the following condition is complied with: the fit characteristic is ascertained; and the corresponding rotational components of the first and the second trajectory are distinct.

5. The method of claim 4, further comprising:
ascertaining undetected positions of the defects on the corresponding rotational components, including:
for at least one missing defect which is detected in an occurrence video frame and undetected in a non-occurrence video frame, ascertaining an undetected position for the missing defect in the non-occurrence video frame by:
identifying a reference defect which is detected in the occurrence and the non-occurrence video frame,
ascertaining a rotation angle of the reference defect by ascertaining a progression of fitted ellipses of the reference defect which correspond to a progression from the occurrence video frame to the non-occurrence video frame;
based on the rotation angle, ascertaining a recovered defect in the non-occurrence video frame, the recovered defect being the undetected position for the missing defect in the non-occurrence video frame,
wherein the video frames include the occurrence frame and the non-occurrence video frame, and wherein the defects include the missing or recovered defect and the reference defect.

6. The method of claim 5, wherein clustering the defects further includes:
ascertaining some of the defects, including the recovered defect, as distinct defects if the following conditions are complied with: the fit characteristic is ascertained; and the corresponding rotational components of the first and the second trajectory are same; and the ascertained positions of the some of the defects are distinct;
ascertaining the some of the defects, including the recovered defect, as same defects if the following conditions are complied with: the fit characteristic is ascertained; the corresponding rotational components of the first and the second trajectory are same; and the ascertained positions of the some of the defects are same.

7. The method of claim 6, further comprising:
based on at least some of the video frames and distinct defects, including the recovered defect, generating at least one modified image which includes an identification of the distinct defects, including the recovered defect.

8. The method of claim 7, further comprising:
based on the modified video frame, ascertaining a count of distinct defects therein.

9. The method of claim 1, wherein ascertaining the trajectories of the defects on the rotational components includes:
based on mapping features of each defect over a plurality of successive frames of the video frames, ascertaining the trajectories.

10. A system for inspection of rotational components, the system comprising:
a memory device storing a plurality of video frames; and
a computing processor communicably coupled to the memory device and configured to:
based on the video frames of the rotation components in motion, ascertain a plurality of trajectories of a plurality of defects on the rotational components;
based on a plurality of fitted ellipses of a plurality of subsets of the trajectories, ascertain a plurality of rotation axes; and
based on a distribution of the rotation axes, ascertain a reference rotation axis for the rotational components.

11. The system of claim 10, wherein the computing processor is further configured to:
cluster the defects by:
for each of a plurality of subsets of the trajectories wherein each subset includes at least a first and a second trajectory:
based on the reference rotation axis and the first and the second trajectory, ascertaining a reference trajectory;
ascertaining fit or non-fit characteristic of the reference trajectory against the first and the second trajectory;
ascertaining the defects which correspond to the first and the second trajectory as distinct defects if non-fit characteristic is ascertained.

12. The system of claim 11, wherein the computing processor is further configured to:
identify corresponding rotational components for the defects by:
for each video frame, ascertaining a rotational component count;
based on the rotational component count and the reference trajectory, assigning the corresponding rotational components to the defects.

13. The system of claim 12, wherein the computing processor is configured to cluster the defects by ascertaining the some of the defects as distinct defects if the following condition is complied with: the fit characteristic is ascertained; and the corresponding rotational components of the first and the second trajectory are distinct.

14. The system of claim 13, wherein the computing processor is further configured to:
ascertain undetected positions of the defects on the corresponding rotational components, including:
for at least one missing defect which is detected in an occurrence video frame and undetected in a non-occurrence video frame, ascertaining an undetected position for the missing defect in the non-occurrence video frame by:
identifying a reference defect which is detected in the occurrence and the non-occurrence video frame,
ascertaining a rotation angle of the reference defect by ascertaining a progression of fitted ellipses of the reference defect which correspond to a progression from the occurrence video frame to the non-occurrence video frame;
based on the rotation angle, ascertaining a recovered defect in the non-occurrence video frame, the recovered defect being the undetected position for the missing defect in the non-occurrence video frame,
wherein the video frames include the occurrence frame and the non-occurrence video frame, and wherein the defects include the missing or recovered defect and the reference defect.

15. The system of claim 14, wherein the computing processor is configured to cluster the defects by:
ascertaining the some of the defects, including the recovered defect, as distinct defects if the following conditions are complied with: the fit characteristic is ascertained; and the corresponding rotational components of the first and the second trajectory are same; and the ascertained positions of the some of the defects are distinct;
ascertaining the some of the defects, including the recovered defect, as same defects if the following conditions are complied with: the fit characteristic is ascertained; the corresponding rotational components of the first and the second trajectory are same; and the ascertained positions of the some of the defects are same.

16. The system of claim 15, wherein the computing processor is further configured to:
based on at least some of the video frames and distinct defects, including the recovered defect, generating at least one modified image which includes an identification of the distinct defects, including the recovered defect.

17. The system of claim 16, wherein the computing processor is further configured to:
based on the modified video frame, ascertain a count of distinct defects therein.

18. The system of claim 10, wherein the computing processor is configured to ascertain the trajectories of the defects on the rotational components by:
based on mapping features of each defect over a plurality of successive frames of the video frames, ascertaining the trajectories.

19. A non-transitory computer-readable medium having computer-readable code executable by at least one computing processor to perform the method according to claim 1.
